(19) United States
(12) Patent Application Publication
(10) Pub. No.: US 2008/0035708 A1
(43) Pub. Date: Feb. 14, 2008

(54) Method of joining strands by mirror welding

(75) Inventors: Jean-Marc Veille, Rennes (FR); Thierry Gaudry, Paris (FR); Jean-Luc David, Taillis (FR)

Correspondence Address: CONNOLLY BOVE LODGE & HUTZ LLP;(FOR CABINET BEAU DE LOMENIE), P.O. BOX 2207, WILMINGTON, DE, 19899-2207, US

(73) Assignee: COOPER-STANDARD AUTOMATIVE FRANCE S.A., Argenteuil (FR)

(21) Appl. No.: 11/763,924

(22) Filed: Sep. 7, 2007

(30) Foreign Application Priority Data
Jun. 16, 2006 (FR) 0652527

(51) Int. Cl. B23K 31/02

(52) U.S. Cl. 228/160

(57) ABSTRACT

The invention relates to a method of making a join between two strands (10, 20). The method comprises cutting each of the two strands at an angle relative to its longitudinal axis so as to obtain a cut surface (13, 23) on each strand. The cut surfaces of the two strands are joined by mirror welding.

The present invention relates to a method of joining together two strands, the method comprising cutting each of the two strands at an angle relative to its longitudinal axis so as to obtain a cut surface on each of the strands.

In bodywork parts that include a window, in particular a sliding window as in a motor vehicle door, it is necessary to provide good sealing between the window and the surrounding metal frame in order to insulate the vehicle cabin from the outside environment. Sealing between windows, whether stationary or moving, and the frame surrounding them is achieved by means of a seal or “weather strip” mounted on the frame. The seal is typically made of rubber or a plastics material (generally a thermoplastic) having rigid regions and regions that are more flexible. It is generally extruded, and thus takes the form of a rectilinear strand of constant section, which section possesses a special profile. It is also possible for it to be molded. At locations where the frame is not rectilinear and changes direction too sharply, or even forms an angle, the thickness and the often-complex profile of the strand mean that the strands cannot fold sufficiently to remain in intimate contact with the frame. The strand thus needs to be made in two portions that are united at the location where there is the greatest change in direction or angle in the frame. The two strand portions then need to be joined together in leaktight manner.

FIG. 7 shows two strands joined together using a prior art method for fitting them to an angle in the frame onto which they are to be mounted. The first strand 110 and the second strand 120 are initially both cut at a given angle relative to their longitudinal axes, thus defining a cut surface 113 on the first strand 110 and a cut surface 123 on the second strand 120. The angles at which the first and second strands 110 and 120 are cut are selected in such a manner that the cut surfaces 113 and 123 come into contact over the entire appearance zone in the angle of the frame where the first and second strands 110 and 120 meet. Thus, when the strands 110 and 120 are identical (FIG. 7), the angles at which the first and second strands are cut are selected to be identical and equal to half the angle of the frame where the first and second strands meet. The appearance zone (the region where the two strands are in contact) is then equal to each of the cut surfaces 113 and 123.

Each strand may be made up of one of more materials. When two materials are used, it is possible for example to have regions of rigid polymer 150 and regions of flexible polymer 160.

The first strand 110 and the second strand 120 are then placed in a mold (not shown) and positioned in such a manner that their cut surfaces 113 and 123 face each other and are spaced apart by a gap 171. The join is then made by injecting flexible polymer 170 into the mold into the gap 171 between the two strands, in the internal region 172 adjacent to the gap 171 beside the reentrant angle formed by the first strand 110 and the second strand 120, and into the external region 173 adjacent to the gap 171 beside the projecting angle formed by the first strand 110 and the second strand 120. Into the internal region 172, just sufficient flexible polymer 170 is injected to unite the edges of the cut surfaces 113 and 123 in a manner that is pleasing in appearance. In the external region 173, just sufficient flexible polymer 170 is injected to join the edges of the cut surfaces 113 and 123 in a manner that is pleasing in appearance. The join is consolidated once the flexible polymer 170 that has been injected into the mold has cooled.

The join between the strands made by injecting the flexible polymer is fragile, and the handling needed to mount the strands 110 and 120 on the metal frame leads to levels of stress (lever arms) that can sometimes lead to the join breaking. Furthermore, a difference in shade appears and becomes worse on aging between an extruded part such as the strands 110 and 120, and a molded part such as the flexible polymer join 170. This difference in shade is undesirable in appearance.

The present invention seeks to remedy those drawbacks.

The invention seeks to provide a method of joining two strands that leads to a join that is stronger and less visible.

This object is achieved by the fact that the method comprises joining the cut surfaces of the two strands by mirror welding. The mirror welding method consists in putting the ends of two parts, typically made of polymer or elastomer, into contact with a hot blade, each end being in contact with a different face of the blade. Once the ends have been heated to the desired temperature, the blade is withdrawn and the ends of the parts are immediately pressed one against the other. On cooling, a permanent weld has been achieved between the two parts.

By means of this disposition, the tear strength of the join between the strands is improved. Furthermore, the pleasing appearance of the join is improved since the cut surfaces of each of the strands come directly into contact with each other.

Advantageously, after joining the cut surfaces, the method includes adding material to at least one of the ends of the mirror weld. Material may also be added in a central region of the mirror weld.

Such added material serves to reinforce the mirror weld. Adding material at the end of the mirror weld that is situated beside the reentrant angle formed between the two strands and at the end of the mirror weld situated beside the projecting angle formed between the two strands also serves, by forming continuous curved surfaces between the edges of the two strands, to obtain a better appearance for the connection between the two strands (rounding the corners between the two strands).

Advantageously, the material is added by injection or by multi-injection.

For example, the injected material can be a flexible thermoplastic.

Typically, the two strands welded together by mirror welding are placed in a mold into which the flexible thermoplastic is injected. This method of adding material is economic in mass production and it is reliable. It is therefore well adapted to making weather strips in the automobile and transport fields.

Advantageously, the mirror welding is performed over the entire section of the cut surfaces.

If the two strands are identical and the angles of cut of the first and second strands are identical and equal to half the angle of the frame where the first and second strands meet, then the cut surfaces of each of the strands come into contact over their entire area. The appearance zone is thus equal to said area. If the strands include lips, the lips of one strand are likewise welded to the facing lips of the other strand. The area of the mirror weld is then maximized, and the strength of the weld is optimized. The lips may also be injected.

Mirror welding can also be used on a fraction only of the sections of the cut surfaces.

When the strands are of different sections, the angles of cut may vary over different intervals along the cut surfaces, so that the cut surfaces thus present the shape of plane surfaces that are perpendicular to a common plane, which surfaces come into contact in the appearance zone. Once united, the cut surfaces will then form a broken line. Where appropriate, the cut surfaces may be non-plane surfaces that come into contact in the appearance zone. Once united, the cut surfaces then form a curved line in a plane that is perpendicular thereto, with the angles of cut varying along said curved line. Under all circumstances, the regions of the cut surface that do not come into contact can be injected using an injection material.

The invention can be well understood and its advantages appear better on reading the following detailed description of an embodiment given by way of non-limiting example. The description refers to the accompanying drawings, in which:

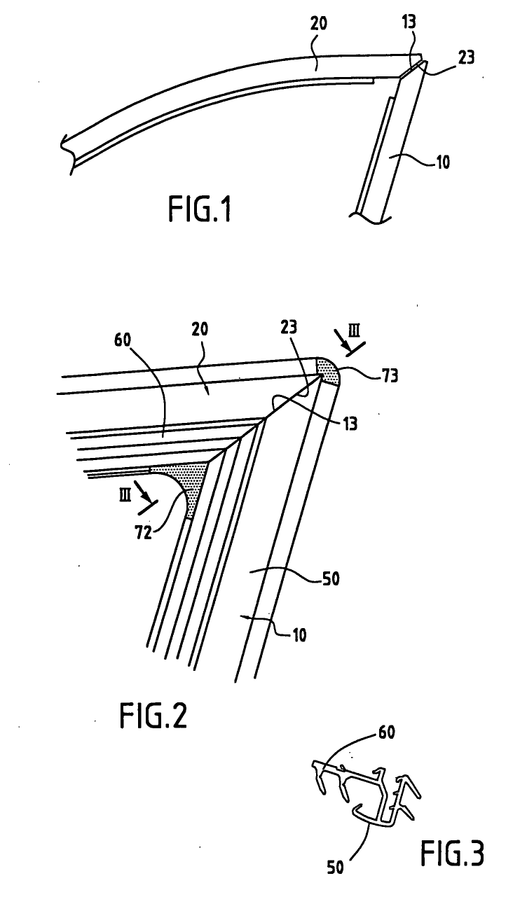

FIG. 1 is a face view of two strands before they are joined together;

FIG. 2 is a face view of a join between two strands made using a method of the invention;

FIG. 3 is a cross-section on line III-III of FIG. 2;

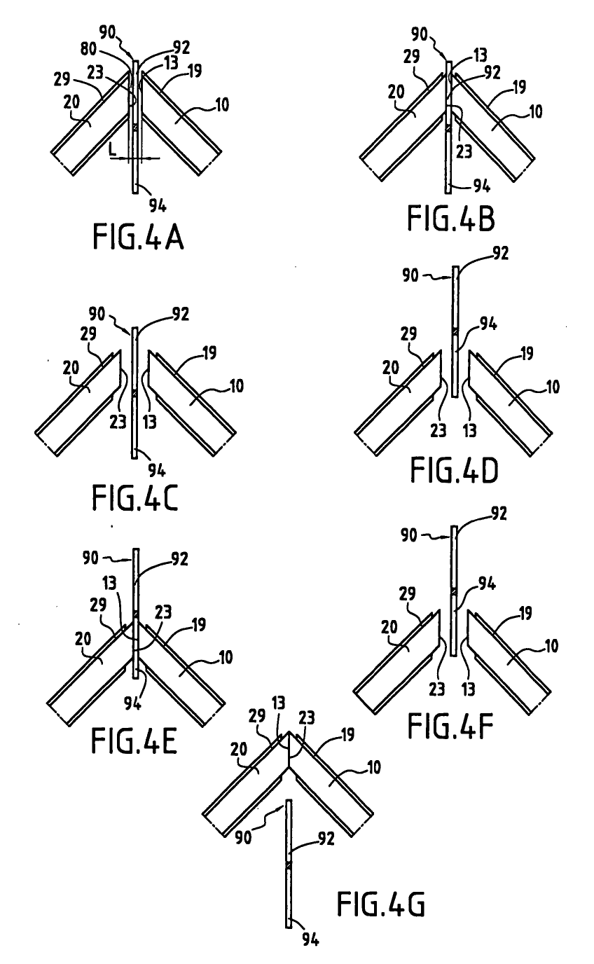

FIGS. 4A to 4G show different steps in mirror welding the two strands in accordance with the invention;

FIG. 5 is a face view of a join between two strands of different sections;

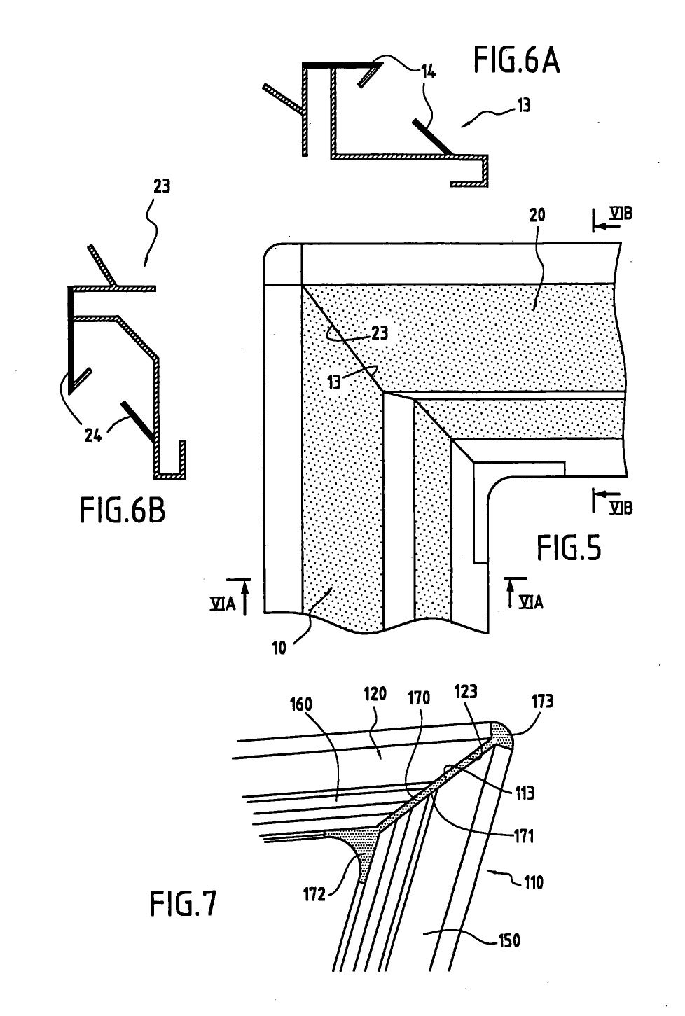

FIGS. 6A and 6B are cross-sections on lines VI-A and VI-B of FIG. 5 respectively; and

FIG. 7 is a face view of a join between two strands made using a prior art method.

FIG. 1 shows a first strand 10 and a second strand 20 placed so as to fit the shape of a frame (not shown) for a motor vehicle door window in which they are to be mounted. The door may be a front door or a rear door. The first and second strands are made by extrusion or by molding. In the example shown, they are identical, possessing the profile shown in FIG. 3, as described below.

The first strand 10 is cut at an angle relative to its longitudinal axis (extrusion axis) thus defining a first cut surface 13. The second strand 20 is likewise cut at an angle relative to its longitudinal axis, thus defining a second cut surface 23. The first strand 10 and the second strand 20 are cut in such a manner that when they are put into position in the door frame that is to receive them, the first cut surface 13 and the second cut surface 23 come into contact with each other. In the present example, the first strand 10 and the second strand 20 are identical, and consequently the first cut surface 13 and the second cut surface 23 both possess the same shape. Furthermore, the angles at which the first and second strands 10 and 20 are cut are selected to the identical and equal to half the angle of the frame where the first and second strands 10 and 20 meet. Under such circumstances, the first cut surface 13 and the second cut surface 23 are exactly identical and superposable, and thus come into mutual contact over their entire section (which thus constitutes the appearance zone).

FIG. 2 shows a join between the first strand 10 and the second strand 20 made using a method of the invention. After the first and second strands 10 and 20 have been cut, the first cut surface 13 and the second cut surface 23 are joined by mirror welding.

After mirror welding, flexible material is added in order to reinforce the mirror welding. For example, this can be done by injecting a flexible thermoplastic into a mold in which the welded-together strands 10 and 20 are placed. The flexible material can be added at one of the two ends of the mirror weld, or at both ends. The material 72 added to the end of the mirror weld situated beside the reentrant angle formed by the first strand 10 and by the second strand 20 also serves, by forming a continuous curved surface between the edges of the two strands, to obtain a better appearance for the connection between the two strands. Similarly, the material 73 added at the end of the mirror weld that is situated beside the projecting angle formed by the first strand 10 and by the second strand 20 forms a continuous curved surface between the edges of the two strands, thus serving to obtain a connection between the two strands that is of better appearance and less sensitive to impacts. When injecting a plurality of materials, it is possible to use multiple injections.

The mirror welding method applied to joining strands is shown in FIGS. 4A to 4G. The first strand 10 is mounted on a first slider 19 having a longitudinal central groove in which the strand can slide. The second strand 20 is mounted on a second slider 29 possessing a longitudinal central groove in which the strand can slide. The end of the first slider 19 is chamfered so that when the end of the first strand 10 is moved in translation along the groove of the first slider 19 to the end thereof, the first cut surface 13 and the end of the first slider 19 lie in the same plane. Similarly, the end of the second slider 29 is chamfered so that when the end of the second strand 20 is moved in translation in the groove of the second slider 29 to its end, the second cut surface 23 and the end of the second slider 29 are situated in the same plane. In FIG. 4A, the first slider 19 provided with the first strand 10 having its first cut surface 13 positioned at the end of the first slider, and the second slider 29 provided with the second strand 20 with its second cut surface 23 positioned at the end of the second slider, are positioned in such a manner that the ends of the first and second sliders are parallel and face each other, being spaced apart by a gap 80. A flat blade 90 of thickness smaller than the initial width L of the gap 80 between the first cut surface 13 and the second cut surface 23 and comprising a cold portion 92 extended in its longitudinal direction by a hot portion 94 is inserted into the gap 80 between the first cut surface 13 and the second cut surface 23 so that one face of the cold portion 92 of the blade 90 faces and is parallel to the first cut surface 13 and the opposite face of the cold portion 92 of the blade 90 faces and is parallel to the second cut surface 23.

In FIG. 4B, the first strand 10 is moved in translation towards the blade 90 along its longitudinal axis until the entire first cut surface 13 is in contact with a face of the cold portion 92 of the blade 90, the first slider 19 remaining stationary. Similarly, the second strand 20 is moved in translation towards the blade 90 along its longitudinal axis until the entire second cut surface 23 is in contact with the opposite face of the cold portion 92 of the blade 90, the second slider 29 remaining stationary. This ensures that the various surfaces remain parallel.

In FIG. 4C, the first strand 10 and the first slider 19 are moved together away from the blade 90 by moving in translation parallel to the longitudinal axis of the first slider, and the second strand 20 and the second slider 29 are moved together away from the blade 90 by moving in translation parallel to the longitudinal axis of the second slider.

The blade 90 can thus be moved in translation longitudinally so that its hot portion 94 becomes positioned in the gap between the first cut surface 13 and the second cut surface 23, and faces and is parallel to the first cut surface 13 and the second cut surface 23, as shown in FIG. 4D.

In FIG. 4E, the first strand 10 is moved in translation towards the blade 90 along its longitudinal axis until the first cut surface 13 comes into contact with a face of the hot portion 94 of the blade 90. Similarly, the second strand 20 is moved in translation towards the blade 90 along its longitudinal axis until the second cut surface 23 comes into contact with the opposite face of the hot portion 94 of the blade 90. This configuration is maintained for the time needed to heat the first and second cut surfaces for the desired time.

In FIG. 4F, the first strand 10 and the first slider 19 are moved together away from the blade 90 in translation parallel to the longitudinal axis of the first slider, and the second strand 20 and the second slider 29 are moved together away from the blade 90 in translation parallel to the longitudinal axis of the second slider.

The blade 90 can then be moved in translation longitudinally so as to be situated no longer in the gap between the first cut surface 13 and the second cut surface 23. The first strand 10 is then moved in translation along its longitudinal axis, and simultaneously the second strand 20 is moved in translation along its longitudinal axis, until the first cut surface 13 comes into contact with the second cut surface 23, as shown in FIG. 4G. The duration between the moment when the cut surfaces are moved away from the hot region 94 of the blade 90 and the moment when they come into contact with each other should be as short as possible. The first cut surface 13 and the second cut surface 23 are held in contact with each other until they have cooled so as to create a permanent join between the first strand 10 and the second strand 20.

Since the first cut surface 13 and the second cut surface 23 are exactly identical, each zone of the first cut surface 13 is welded to the zone of the second cut surface 23 that is symmetrical therewith about the join between the first and second strands 10 and 20.

As shown in FIG. 3, which shows the first cut surface 13 or the second cut surface 23, each strand is made up of one or more zones of rigid polymer 50, together with one or more zones of flexible polymer 60. By way of example, these polymers are thermoplastics. Certain portions of the flexible polymer zones may be flocked. After mirror welding, the rigid polymer zones of one of the strands are in contact with the rigid polymer zones of the other strand, and the flexible polymer zones of one of the strands are in contact with the flexible polymer zones of the other strand. The portions made of added material 72 and 73 in FIG. 2 are not shown here.

In another configuration, rigid polymer zones can be welded to flexible polymer zones.

FIG. 5 shows the join between a first strand 10 and a second strand 20 when the two strands are of different sections. FIG. 6A is a cross-section of the first strand 10, and FIG. 6B a cross-section of the second strand 20. The facing portions of each strand, portions 14 of the first strand 10 and portions 24 of the second strand 20, as shown in FIGS. 6A and 6B respectively, constitute the appearance zone. It is these portions 14 and 24 that are welded together by mirror welding. The angle of cut may vary over different intervals along the first cut surface 13 of the first strand 10 and along the second cut surface 23 of the second strand 20 so that their portions 14 and 24 do indeed face each other. In the plane perpendicular to the cut surfaces, the cut surfaces, once united, thus form a broken line 7. The blade 90 used for performing mirror welding then needs to have a staircase profile matching the broken line 7.

The method of the invention is described above for making a join between two strands that meet at a place where the frame in which they are to be mounted forms an angle. The method also applies to making a join between two strands that meet at a location where the frame is curved progressively. The method also applies to making a join between two strands that meet at a location where the frame is rectilinear.

1. A method of making a join between two strands (10, 20), the method comprising cutting each of said two strands at an angle relative to its longitudinal axis so as to obtain a cut surface (13, 23) on each of said strands, and being characterized in that it comprises joining said cut surfaces of the two strands by mirror welding.

2. A method according to claim 1, characterized in that, after joining said cut surfaces, it includes adding material to at least one of the ends of said mirror weld.

3. A method according to claim 2, characterized in that said material is added by injection.

4. A method according to claim 3, characterized in that said injected material is a flexible thermoplastic.

5. A method according to claim 1, characterized in that said mirror welding is performed over the entire section of each cut surface.

6. A method according to claim 1, characterized in that said mirror welding is performed over a fraction only of the section of each cut surface.

7. A method according to claim 4, characterized in that said mirror welding is performed over the entire section of each cut surface.

8. A method according to claim 4, characterized in that said mirror welding is performed over a fraction only of the section of each cut surface.

9. A method according to claim 2, characterized in that said mirror welding is performed over the entire section of each cut surface.

10. A method according to claim 3, characterized in that said mirror welding is performed over the entire section of each cut surface.

11. A method according to claim 2, characterized in that said mirror welding is performed over a fraction only of the section of each cut surface.

12. A method according to claim 3, characterized in that said mirror welding is performed over a fraction only of the section of each cut surface.
